(19) United States
(12) Patent Application Publication
(10) Pub. No.: US 2021/0064383 A1
(43) Pub. Date: Mar. 4, 2021

(54) DEVICE BOOT UP TIME USING SEGMENT READ SCHEDULING

(71) Applicant: QUALCOMM Incorporated, San Diego, CA (US)

(72) Inventors: Naresh Kumar SHARMA, Hyderabad (IN); Pravin KUMAR, Faridabad (IN); Saurabh GORECHA, Hyderabad (IN)

(21) Appl. No.: 16/557,676

(22) Filed: Aug. 30, 2019

(51) Int. Cl. G06F 9/4401; G06F 9/48

(52) U.S. Cl. CPC G06F 9/4406; G06F 9/4881

(57) ABSTRACT

Aspects of the disclosure relate to improving device boot up time and subsystem availability time in a computing system using segment read scheduling. The segment read scheduling is a scheduling of order for loading subsystem images for a number of subsystem images from a memory during boot up or reset of the computing system and is based on a determined criticality value calculated from various parameters including subsystem image size, the priority of the subsystem. Additionally, the scheduled segment loading is performed according to numerous parallel loading schemes using multiple direct memory access engines and cryptography engines to increase the speed of loading the images and bringing them out of boot up or reset. Other aspects, embodiments, and features are also claimed and described.

### TECHNICAL FIELD

The present disclosure relates generally to computing devices and systems, and more particularly, to methods and apparatus for improving device boot up time and subsystem availability time using segment read scheduling.

### INTRODUCTION

In a computing system or device, such as a System on a Chip (SoC), when the system or device is booted up or initialized, such as during a power on or reset, various devices are initialized by reading initialization codes, files, firmware images, or disk images (also known as a “boot image” or simply an “image”) from memory storage devices. In complex systems employing an SoC, like a mobile chipset used in a mobile communication device, a core processor, Application Processor (AP) or similar central processing unit generally supervises the overall boot up processes for various subsystems, which may be resident on the SoC, such as a modem, a neural processing unit (NPU), or a digital signal processor (DSP), as examples.

In particular, the AP triggers the loading of images from secondary storage devices, such as an external non-volatile storage device (e.g., Flash or NAND storage devices), and initializes essential or mandatory peripherals such as an external double data rate (DDR) random access memory (RAM), on-chip memory devices (e.g., IMEM), embedded Multi-Media Controllers (eMMCs), non-volatile memory (e.g., NVM devices such as Flash or NAND memory storage devices), and so forth by reading images from the secondary storage to boot up the various subsystems. As part of the subsystem initialization, the firmware images are validated to ensure security. As part of this process, data, such as metadata as one example, is read and sent to an authentication device for secure authorization including signature validation. If there is successful signature validation, image segments are sequentially read from an NVM device or DDR, as examples, and passed to secure execution environment, such as ARM's Trustzone®, as one example, for integrity checks. Further, a crypto engine is used to calculate a segment hash and verify the integrity with provided metadata and image segments in order to complete loading of the images. This process can take up a lot of time during a boot up depending on the image sizes and the number of images. Furthermore, subsystem services are not activated until the firmware image is loaded and authenticated. This leads to delay in subsystem availability time.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

According to aspects of the present disclosure, a method for booting a computing system is disclosed. The method includes determining a criticality value for each of a plurality of subsystems based on determined parameters, and selecting a loading characteristic by which subsystem images corresponding to the one or more of the plurality of subsystems is read from a storage device into the computing system. Further, the method includes scheduling an order of loading the subsystem images from the storage device into the computing system based on the determined criticality value and the selected loading characteristic for booting up the plurality of subsystems in the computing system.

According to another aspect, an apparatus for booting a computing system is disclosed. The apparatus includes means for determining a criticality value for each of a plurality of subsystems based on determined parameters. Also, the apparatus includes means for selecting a loading characteristic by which subsystem images corresponding to the one or more of the plurality of subsystems are read from a storage device into the computing system Furthermore, the apparatus includes means for scheduling an order of loading the subsystem images from the storage device into the computing system based on the determined criticality value and the selected loading characteristic for booting up the plurality of subsystems in the computing system.

According to yet another aspect, a computer-readable medium storing computer-executable code is disclosed. The medium includes code for causing a computer to: determine a criticality value for each of a plurality of subsystems, which are executable on a computing system, based on determined parameters and to select a loading characteristic by which subsystem images corresponding to the one or more of the plurality of subsystems are read from a storage device into the computing system. Additionally the medium includes code for causing a computer to schedule an order of loading the subsystem images from the storage device into the computing system based on the determined criticality value and the loading characteristic for booting up the plurality of subsystems in the computing system.

Yet another aspect disclosed includes an apparatus including at least one processor and at least one memory storage communicatively coupled to the at least one processor. The at least one processor is configured to determine a criticality value for each of a plurality of subsystems based on determined parameters and to select a loading characteristic by which subsystem images corresponding to the one or more of the plurality of subsystems are read from a storage device into the computing system. Additionally, the at least one processor is configured to schedule an order of loading the subsystem images from the storage device into the computing system based on the determined criticality value and the selected loading characteristic for booting up the plurality of subsystems in the computing system.

These and other aspects of the invention will become more fully understood upon a review of the detailed description, which follows. Other aspects, features, and embodiments will become apparent to those of ordinary skill in the art, upon reviewing the following description of specific, exemplary embodiments in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a block diagram of an exemplary computing system environment in which the present methods and apparatus may be employed.

FIG. 2 is a sequence diagram illustrating an exemplary system boot up environment in which the present methods and apparatus may be employed.

FIG. 3 illustrates a timing diagram of subsystem service availability and the boot times of various subsystems in an exemplary computing system environment.

FIG. 4 illustrates a flow chart illustrating a method for booting a computing system according to some aspects of the present disclosure.

FIG. 5 is a sequence diagram illustrating an exemplary system boot up according to some aspects of the disclosure.

FIG. 6 illustrates a timing diagram of an example of parallel loading of segments of subsystem images according to some aspects of the disclosure.

FIG. 7 is a sequence diagram illustrating another exemplary system boot up according to some aspects of the disclosure.

FIG. 8 illustrates a timing diagram of an example of parallel loading of subsystem images according to some aspects of the disclosure.

FIG. 9 illustrates a timing diagram of an example of combined parallel loading of segments of subsystem images and the subsystem images according to some aspects of the disclosure.

FIG. 10 is a flow chart illustrating exemplary process for scheduling subsystem image read order according to some aspects of the disclosure.

FIG. 11 is a table illustrating an example of scheduling resulting from the process of FIG. 10.

FIG. 12 is a flow chart illustrating another exemplary process for scheduling subsystem image read order according to some aspects of the disclosure.

FIG. 13 is a further table illustrating an example of scheduling resulting from the process of FIG. 12.

FIG. 14 is a block diagram conceptually illustrating an example of a hardware implementation for a computing system in a device such as a wireless communications device according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes and constitution.

It is also noted that the word “exemplary” is used herein to mean “serving as an example, instance, or illustration.” Any embodiment or example described herein as “exemplary” is not necessarily to be construed as preferred or advantageous over other embodiments.

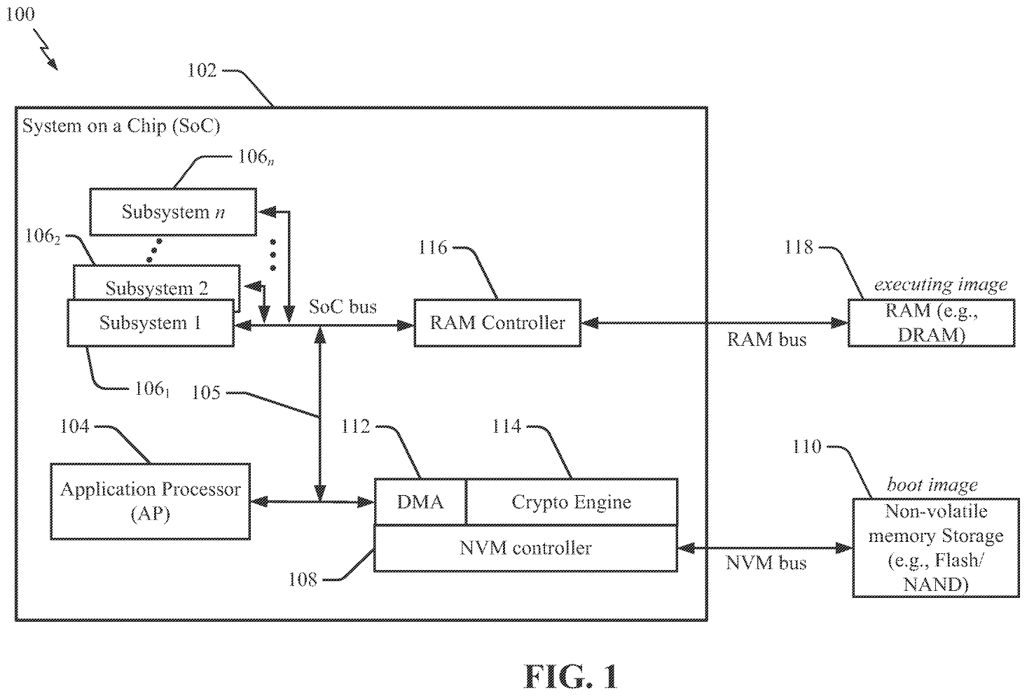

FIG. 1 illustrates an exemplary computing system 100 in which the presently disclosed methods and apparatus may be implemented. The system 100 may include a System on a Chip (SoC) 102, but the concepts disclosed herein are applicable to other types of computing systems that employ a core processor that generally supervises boot up of peripheral devices or similar various subsystems. The SoC 102 includes a core or application processor (AP) 104 communicatively coupled to a bus 105 (e.g., an SoC bus) that communicatively couples the AP 104 with various processing circuitry and hardware containing within the SoC. The SoC 102 further includes one or more peripheral devices or “subsystems” 106 (shown as an “n” number of subsystems 1 through n and denoted with reference numbers 106, through 106ₙ). In the example of a SoC used in mobile wireless device, examples of various subsystems may include a graphics processing unit (GPU), an IP accelerator (IPA), a modem unit, a wireless local area network (WLAN) integrated modem unit, a WLAN (e.g., WiFi), a wide area network (WAN) modem, a digital signal processor (DSP) such as computational DSP (CDSP) or an audio DSP (ADSPs), a video processor, a camera unit, a power monitor, a neural processing unit (NPU), or any other application subsystem whose image is to be loaded. According to further alternative aspects, the AP 104 may be configured to act as a “master subsystem” that, in turn, helps in the loading and authenticating of the images of the other coprocessor subsystems. In still further aspects, it is noted that SoC 102 may also be configured such that a particular subsystem is operable for loading and authenticating the other remaining subsystems of the SoC 102, where that particular subsystem acts as the “master subsystem.” In yet a further aspect, it will be appreciated by those skilled in the art that the subsystem may be resident with the SoC 102, but in other aspects, one or more subsystems might also be external to the SoC and are called/loaded by the AP 104 or other “master subsystem.”

SoC 102 further includes a non-volatile memory (NVM) controller 108 used to access files, such as boot images, from a non-volatile memory (NVM) storage device 110, which may constitute a Flash or NAND NVM device and is considered a “secondary” storage device as the working or executable files are not read from this device 110. The NVM controller 108 may be associated with direct memory access (DMA) controller hardware or circuitry 112 (also referred to as a “DMAC”) known in the art, which is configured to offload memory access (i.e., read and writes) processes from the AP 104 and effectuate the reading and loading of files or images from the NVM storage device 110 in conjunction with the NVM controller 108 (or incorporating the functions of the NVM controller 108 in some other aspects).

Additionally, the SoC 102 may include cryptography engines or “crypto engines” exemplified by crypto engine 114. The crypto engine(s) 114 implement authentication and check the integrity of images loaded from the NVM storage device 110 as will be explained in further detail later. Further, SoC 102 includes a RAM controller 116 communicatively coupled to the bus 105, where the RAM controller 116 serves to read and write files or images to a random access memory (RAM) 118, such as a DDR DRAM, static RAM (SRAM), instruction memory (IMEM), Tightly-Coupled Memory (TCM), Low-Power Double Data Rate (LPDDR) RAM, or equivalents that may serve as the main memory in which executable files are written to and read from. In an aspect, the boot images loaded from NVM storage device 110 are loaded via control of the AP 104, NVM controller 108, and DMA 112 after authentication and checks by the crypto engine 114, to the RAM 118 as executable images that are used by the AP 104 to bring up the subsystems 106 during power on reset.

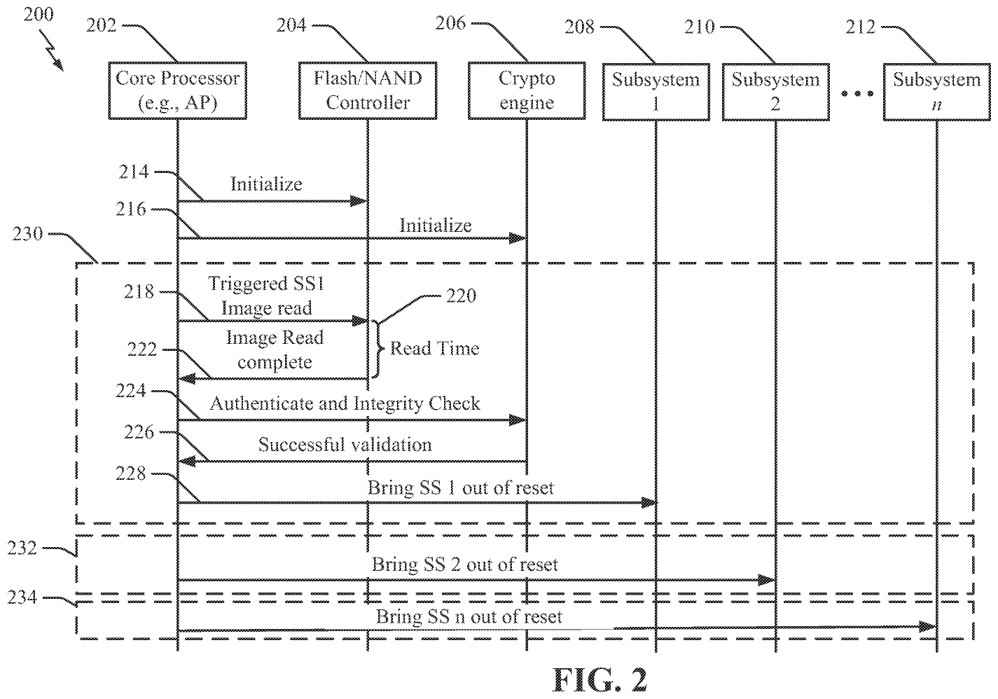

FIG. 2 is a time sequence diagram 200 illustrating an exemplary system boot up for the system 100 of FIG. 1. As shown, the various hardware and/or software elements involved include a core processor 202 (e.g., AP 104), a Flash/NAND controller 204 (e.g., NVM controller 108 in FIG. 1), one or more crypto engines 206 (e.g., crypto engine 114 in FIG. 1), and various subsystems 1 through n illustrated by exemplary subsystems subsystem 1 208, subsystem 2 210, and subsystem n 212.

During a cold boot or reset boot, the mandatory peripherals such as Flash/NAND controller 204 and crypto engine 206 are initialized typically under control of the core processor 202 as shown by initialization signaling 214 and 216. It is to be understood that, although not illustrated for sake of clarity, other devices such as a DMA, secondary NVM memory storage device, DRAM, and RAM controller may be included in the initialization processes for the peripheral devices. Once the peripherals are initialized, boot images are started loading from the secondary NVM storage device (e.g., NVM storage device 110) as shown at 218. This process at 218 may include triggering by the core processor 202 of the Flash/NAND controller 204 to load or read the image from the secondary NVM (e.g., NVM storage device 110).

After a read time period 220 in which all segments of an image for the subsystem are read (e.g., subsystem 1 as shown in this example), an indication may be sent by the Flash/NAND controller 204 to the core processor 202 that the image read is complete as shown at 222. Once the complete subsystem image is read, the core processor 202 may send various read data, such as metadata and image segments, to the crypto engine 206 to perform authentication and integrity checks to validate the loaded image as shown at 224. In one example, the crypto engine 206 may utilize a trusted execution environment (TEE) application such as Trustzone® developed by ARM, but is not limited to such. If the validation performed by the crypto engine 206 is successful, an indication of such may be sent to the core processor 202 as shown at 226.

In further aspects, it is noted that the process indicated at 224 may include first determining authentication of the images using the crypto engine 206 using the TEE environment (e.g., Trustzone®) for authentication and writing the authenticated image segments to RAM (e.g., RAM 118). The integrity check may be further implemented by reading the segments from RAM and passing these segments to the TEE environment (e.g., Trustzone®) for integrity checks, such as through calculating a cryptographic hash value to verify the integrity of the image using the provided metadata.

After successful validations, the subsystem (e.g., subsystem 1 208) is then brought out reset (booted up) by the core processor 202 as shown at 228. The processes of reading, validating, and booting up a subsystem are shown subsumed within a repeatable loop 230, which is enclosed by a box to show the processes involved in the repeatable loop. These processes in repeatable loop 230 are thus repeated for each of the n number of subsystems. Although abbreviated, subsequent executions of the processes of loop 230 occurring in time are illustrated by boxes 232 and 234 for booting up the various n number of subsystems.

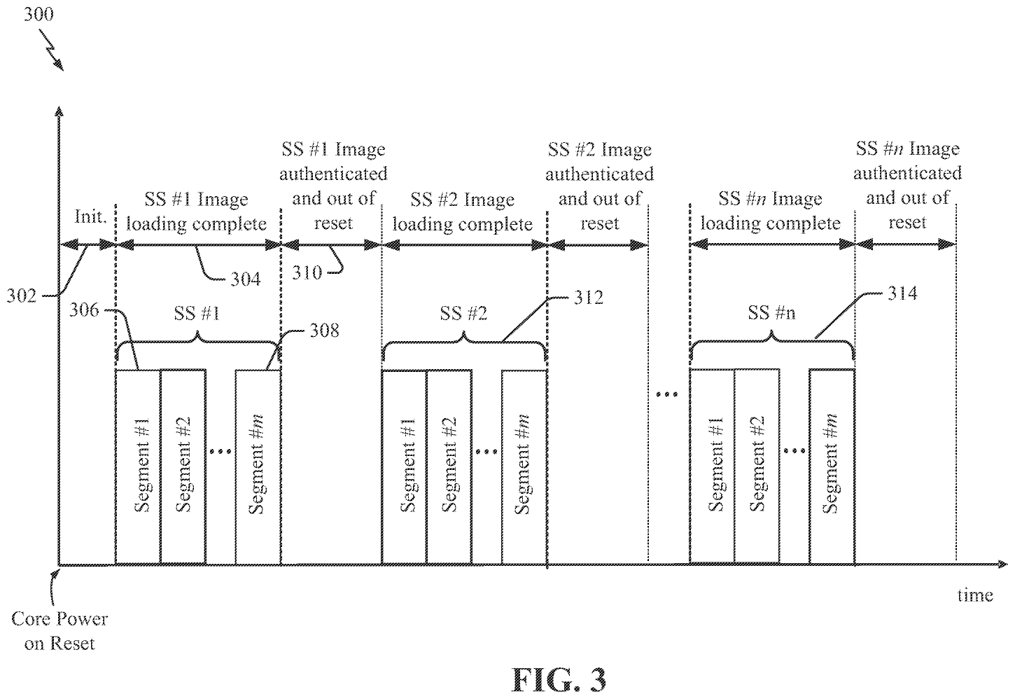

It is noted that the processes shown in sequence diagram 200 may take a lot of time during boot up of the system as a whole depending on the image sizes and the number of images to be brought out of reset. As an illustration of the time involved, FIG. 3 shows a timing diagram 300 of the relationship of subsystem service availability and the boot times of the various n number of subsystems. As shown, after the initialization of the mandatory peripheral devices (time period 302), segments for a first subsystem (SS #1) are loaded. The time 304 for the complete image loading depends on the size (shown uniform in the time and y axes for sake of simplicity but not limited to such uniformity) of the segments 1 (306) through m (308). The time for loading the complete subsystem image (e.g., 304) will be the sum of the time periods for segments 1 through m.

After loading of the subsystem image is completed, then a further time period 310 occurs while the image is authenticated and the subsystem is brought out of reset. Subsequently, a next subsystem image 312 is loaded and so on until the n total subsystem images (e.g., 314) are loaded and each subsystem is brought out of reset. The total time for booting all subsystems in the system as a whole is then the summation of time taken to load all segments of all subsystem images, as well as the image authentication and subsystem reset times (e.g., 310). Typically, subsystem services are not activated until the firmware image is completely loaded and authenticated. This constraint in the processes shown in FIGS. 2 and 3 leads to delays in the subsystem availability time. As will be further appreciated from FIG. 3, the subsystem readiness is directly proportional to subsystem image loading order. While the subsystem loading order is not necessarily limited to a set order and may be order according to predetermined priorities of the subsystems in the system as a whole, the methodology of FIGS. 2 and 3 have limitations in that the subsystem images are read out of storage sequentially as shown in FIG. 3 limiting the boot timelines, as well as not accounting for other factors beyond priority that may actually yield that loading the highest priority subsystem may not always result in the fastest boot up time for the system as a whole.

In light of the timing challenges that arise with the processes illustrated by FIGS. 2 and 3, the present disclosure provides methods and apparatus that improve system performance by changing the way that subsystem images are loaded into a computing system such as system 100 through (1) different types or characteristics of parallel loading/processing to more quickly load the subsystem images, as well as (2) scheduling the order in which subsystems will be loaded based on a criticality determination in order to move critical subsystems out of reset before less critical subsystems. These methods result in an overall faster boot up of the whole system (e.g., an SoC system).

In particular, it is noted that the methodology disclosed herein prioritizes subsystem image segments or the subsystem image itself based on a criticality of a subsystem, where criticality is a measure of the order of criticality that a subsystem, where this measure may be based on one or more factors such as the priority of the subsystem, the number of segments in a subsystem image, the size of the image of the subsystem, and the number of hardware resources available in the system (e.g., the number of crypto engines and DMA engines in the system), as examples. The loading of subsystem images may be scheduled based on the criticality in order to increase the overall faster boot up of the system as a whole. Further, the methods include utilizing parallel processing or handling when loading subsystem image segments to more quickly load the subsystem images to improve subsystem availability in the boot up timeline. A number of different methods for implementing specific scheduling and parallel loading of images are disclosed and will be discussed in more detail later. It is further noted that the type of parallelism along with the scheduling used affects how the criticality of the subsystems are determined as will also be described in more detail below.

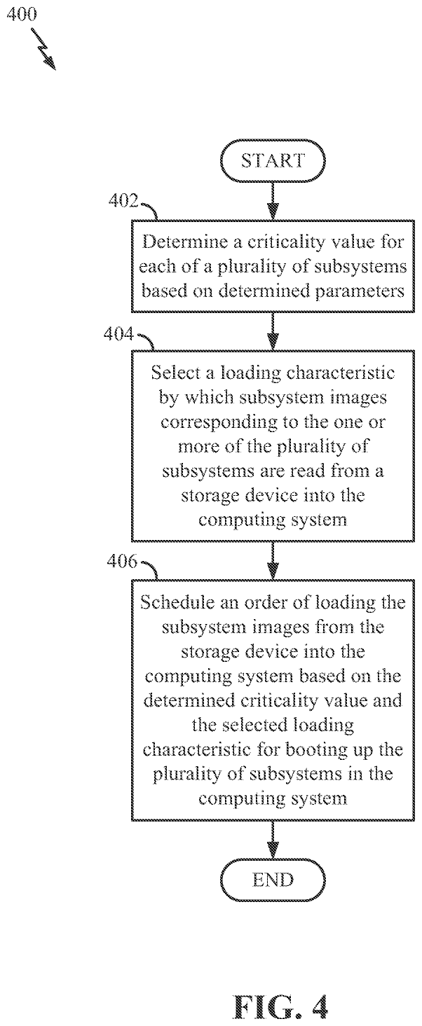

FIG. 4 illustrates a flow diagram of a method 400 for booting a computing system according to an aspect of the disclosure. In contrast to the methodology of FIGS. 2 and 3, it noted here that method 400 accounts for subsystem criticality that is measured different from a mere priority of a subsystem, and will result in higher efficacy for achieving the fastest boot flow time for a system as a whole by moving the more critical subsystems' loading sooner in the loading schedule rather than just ordering according to priority. Moreover, the disclosed methods and apparatus discussed in connection with FIGS. 4-14 are further differentiated from the methods of FIGS. 2 and 3 in that they employ scheduling of image loading along with various types of processing, such a parallel processing. In particular, the presently disclosed scheduling provides for the selection of a one of a number of parallel processing characteristics to load and authenticate the loaded image segments. As will be discussed in further detail later, these parallel processing characteristics include parallelism of loading and authenticating segments of a single image using multiple DMAs and crypto engines, parallelism and interleaving of the loading and authenticating of multiple segments in various images using the DMA & crypto engines, and also may include a combination of single image parallelism and multiple segment parallelism.

As shown in FIG. 4, method 400 specifically includes determining subsystem criticality for a plurality of subsystems based on determined parameters as shown at block 402. These determined parameters may include one or more of the size of a subsystem image and segments thereof and a predetermined priority of a subsystem, as well as various predetermined relationships and the number of available DMAs and crypto engines as will be discussed in more detail later. In further aspects, the determined parameters may be derived from metadata read from an executable and linkable format (ELF) image file, and these parameters can be different for different images. Additionally, the predetermined priority of subsystems may be based on use-cases of the subsystems where priority is determined from historical usage of subsystems in a particular system. As an example, an internet of things (IoT) device may require a modem subsystem (and its associated DSP subsystem) can have a higher predetermined priority compared to a mobile device.

Additionally, method 400 includes selecting a loading characteristic by which the subsystem images will be read or loaded from a storage device, such as NVM storage device 110. The loading characteristic, as mentioned above, includes parallelism of loading and authenticating segments of a single image using multiple DMAs and crypto engines, parallelism and interleaving of the loading and authenticating of multiple segments in various images using the DMA & crypto engines, or a combination of single image parallelism and multiple segment parallelism.

After the criticality and loading characteristics are determined and selected in blocks 402 and 404, the order of the loading of the subsystem images into the computing system (e.g., system 100) is scheduled based on the determined criticality and the selected loading characteristic as shown in block 406. As will be explained in more detail below, how the scheduling of the subsystem loading order is determined will change dependent on which loading characteristic is selected. In further aspects, the determination of the criticality may be determined differently based on the selected loading characteristic. Accordingly, is also noted here that although the processes in blocks 402 and 404, while being shown in a particular linear order, are not limited to such and these processes may occur in the reverse order or may occur simultaneously or in concurrence.

In general, method 400 in FIG. 4 includes deciding, based on a determined criticality factor or value of a subsystem, which subsystem to bring out of reset first. It is noted that the processes of method 400 may be implemented after the mandatory peripheral devices are initialized, such as the DRAM, on chip memory devices, the NVM storage device, DMA engines, and crypto engines, as examples. The determination of the criticality value may be based on read metadata information of all subsystem images from the NVM storage device. Further metadata that may be used in making scheduling decisions for the order of bringing subsystems out of reset includes the total segments in a subsystem image, and the number of available hardware resources (e.g., DMAs and crypto engines). In further aspects, it is noted that the available resources are not limited to DMAs and crypto engines, and could also include software cryptographic algorithms that are capable of being run on performance intensive cores with core-affinity attached to the cryptographic algorithms.

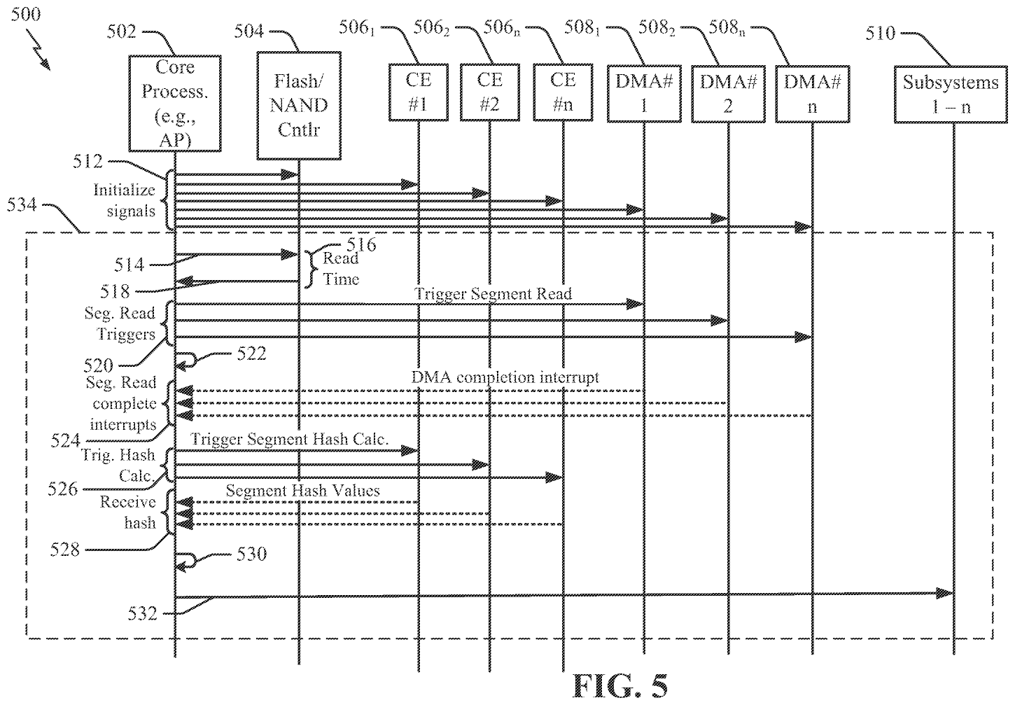

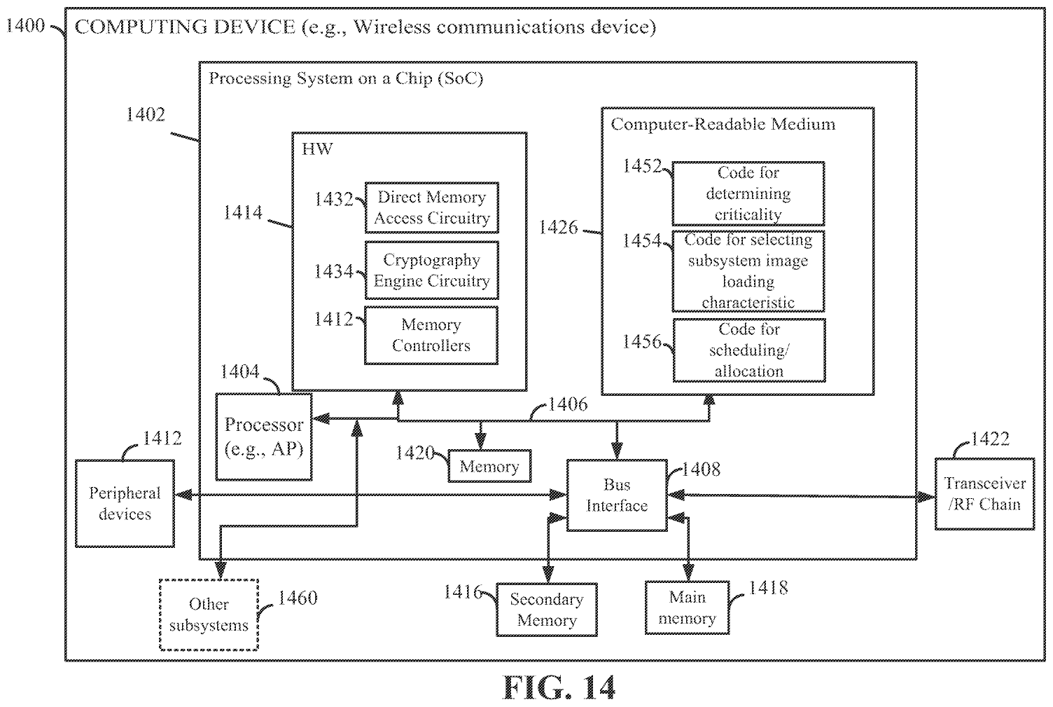

In particular aspects, it is noted that the processes of FIG. 4 (as well as the processes illustrated in FIGS. 5-13 to be discussed below) may be implemented by various means. In particular, the process of block 402 may be performed by means for determining a criticality value for each of a plurality of subsystems based on determined parameters. In various examples, this means may be implemented by AP 104 in FIG. 1, processor 1404 (to be discussed later with respect to FIG. 14), hardware 1414 (to be discussed later with respect to FIG. 14), a subsystem acting as a “master subsystem” (e.g., 106) or some equivalent hardware, software, or combination thereof. Furthermore, the process of block 404 may be performed by means for selecting a loading characteristic by which subsystem images corresponding to the one or more of the plurality of subsystems is read from a storage device into the computing system. This means may be implemented by AP 104 in FIG. 1, a processor 1404 (to be discussed later with respect to FIG. 14), hardware 1414 (to be discussed later with respect to FIG. 14), a subsystem acting as a “master subsystem” (e.g., 106) or some equivalent hardware, software, or combination thereof. Yet further, in some aspects the process of block 406 may be performed means for scheduling an order of loading the subsystem images from the storage device into the computing system based on the determined criticality value and the selected loading characteristic for booting up the plurality of subsystems in the computing system. This means may be implemented by AP 104 in FIG. 1, a processor 1404 (to be discussed later with respect to FIG. 14), hardware 1414 (to be discussed later with respect to FIG. 14), a subsystem acting as a “master subsystem” (e.g., 106) or some equivalent hardware, software, or combination thereof.

FIG. 5 is a time sequence diagram of specific methodology for boot up of a computing system falling within the methodology disclosed in FIG. 4. In particular, it is noted that FIG. 5 illustrates a method for boot up using parallelism for loading subsystem image segments for a single image in parallel. As shown, FIG. 5 illustrates various hardware and/or software elements involved include a core processor 502 (e.g., AP 104 in FIG. 1), a Flash/NAND controller 504 (e.g., NVM controller 108 in FIG. 1), an n number of crypto engines 506 ₁ through 506ₙ (e.g., crypto engine 114 in FIG. 1), an n number of DMA engines 508₁ through 508ₙ, and various subsystems 1 through n illustrated by block 510.

During a cold boot or reset boot, the mandatory peripherals such as Flash/NAND controller 504, crypto engines 506 , and DMAs 508 are initialized typically under control of the core processor 502 as shown by initialization signaling 512. It is to be understood that, although not illustrated for sake of clarity, other devices such as a secondary NVM memory storage device, DRAM, and RAM controller may be included in the initialization processes for the peripheral devices. Once the peripherals are initialized, the core processor 502 triggers the Flash/NAND controller 504 to initiate the reading of a first scheduled subsystem image from the secondary NVM storage device (e.g., NVM storage device 110) as shown at 514.

After a processing time period 516, the Flash/NAND controller 504 sends back a signaling that includes details of the segments size and start information, included in sub system image metadata as indicated at 518. The core processor 502, in turn, then issues read triggers to each of the DMAs 508 to begin reading corresponding subsystem image segments of an x number of segments, where each respective segment may be assigned to a corresponding DMA 508 that, in turn, reads the respective segment from the second NVM storage device (e.g., NVM storage device 110). It is noted that the reading of each segment of the x number of segments for a single subsystem image may be performed in parallel where the DMA engines 508 operate concurrently for reading their respective image segment.

According to one example, while the core processor 502 waits for the DMAs to read the subsystem image segments, the core processor 502 may be placed in a sleep mode as indicated at arrow 522. Once the DMAs 508 complete the reading of their respective image segment, they may each issue an interrupt signal to wake up the core processor 502 as shown at 524, whereby the DMAs indicate to the core processor 502 that the read or loading of the image segment is completed. After the image segments are loaded, the core processor 502 will trigger or initiate respective crypto engines 506 to calculate the hash values for each of the corresponding segments assigned to the crypto engines 506 as shown at 526. Similar to the operation of the DMAs 508, each of the crypto engines 506 may operate in parallel where the hash values are calculated in parallel by respective ones of the crypto engines 506 for each of the x number of segments for a single subsystem image.

Once all segments hashes are calculated by the crypto engines 506 and returned to the core processor 502 as shown at 528, the complete subsystem image may then be authenticated. Further, the core processor 502 may check the integrity of the segments by combining all of the hashing values, which is illustrated by arrow 530. If the authentication and integrity checks are successful, the corresponding subsystem (e.g., subsystem 1) of the n number of subsystems is then brought out of reset (booted up) by the core processor 502 as shown at 532. The processes of reading, validating, and booting up a subsystem are shown subsumed within a repeatable loop indicated by box 534. These processes in loop 534 are thus repeated for each of the n number of subsystems. As will be evident to those skilled in the art, the processes shown in the sequence 500 operate such that the multiple DMAs 508 and crypto engines 506 work in parallel and load the subsystem image faster than a traditional boot flow.

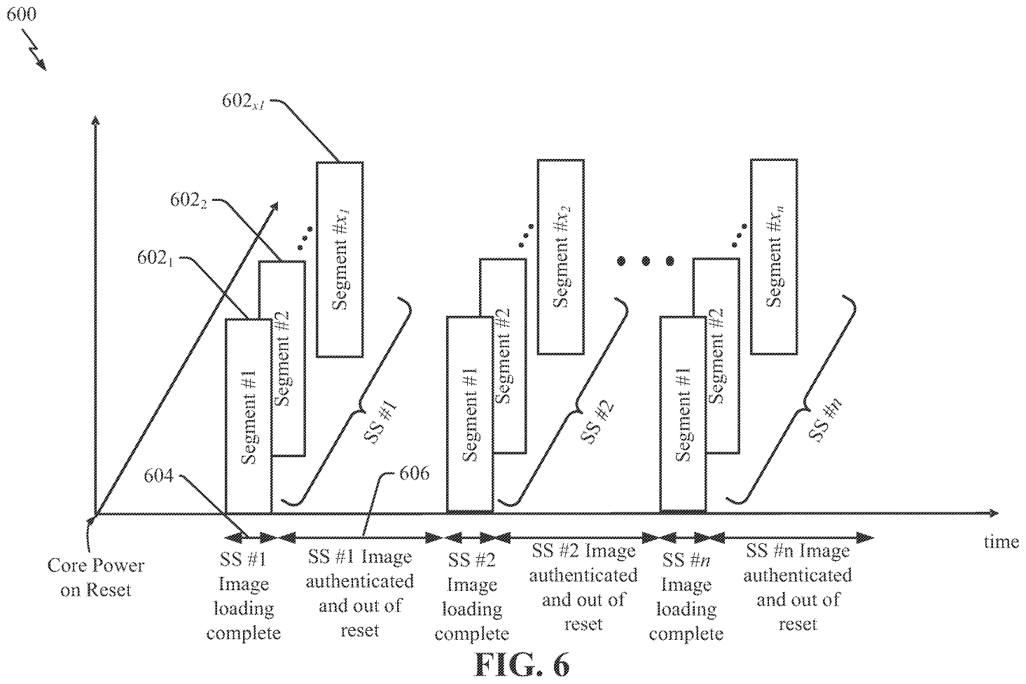

FIG. 6 illustrates a timing diagram 600 of an example of parallel loading of segments of subsystem images service and times of boot up of the subsystems according to some aspects of the disclosure. In particular, FIG. 6 provides an illustration of the timing of segment loading and boot up of subsystems in accordance with the example of FIG. 5 for the various n number of subsystems. As shown, after the core power on (and some time of initialization of the mandatory peripheral devices (not called out but visible at the time prior to SS #1 loading after the core power on reset), all n number of segments 602₁ through 602ₓ₁ for a first subsystem (SS #1) are loaded in parallel such that the image loading is completed within a time 604 approximately equal to the loading time of the longest or maximum length segment. The time 604 for the complete image loading depends on the size (shown uniform in the time in x axis and y axis for sake of simplicity but not limited to such uniformity) of the segments 602.

After loading of the subsystem image of SS #1 is completed, the image authentication and bringing the subsystem out of reset occurs over a further time period 606. Subsequent subsystem images SS #2 through SS #n are then loaded and brought out of reset further illustrated in FIG. 6, which generally results in the whole system being brought out of reset (i.e., boot up of the system such as system 100). As will be appreciated by those skilled in the art, the total time for loading the complete system including the n subsystem time will be equal to the SS #1(Max length segment)+SS #2(Max length segment)+ . . . +SS #n(Max length segment). Accordingly, the total time of system boot is proportional to the maximum segment size of all segments of each of the subsystems.

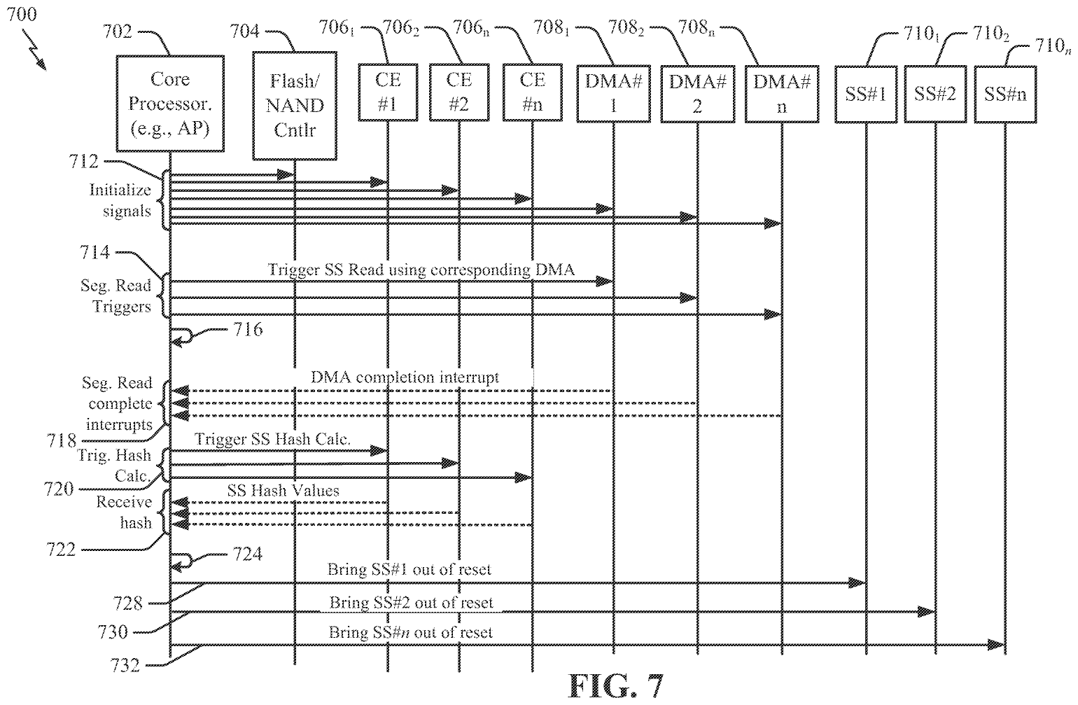

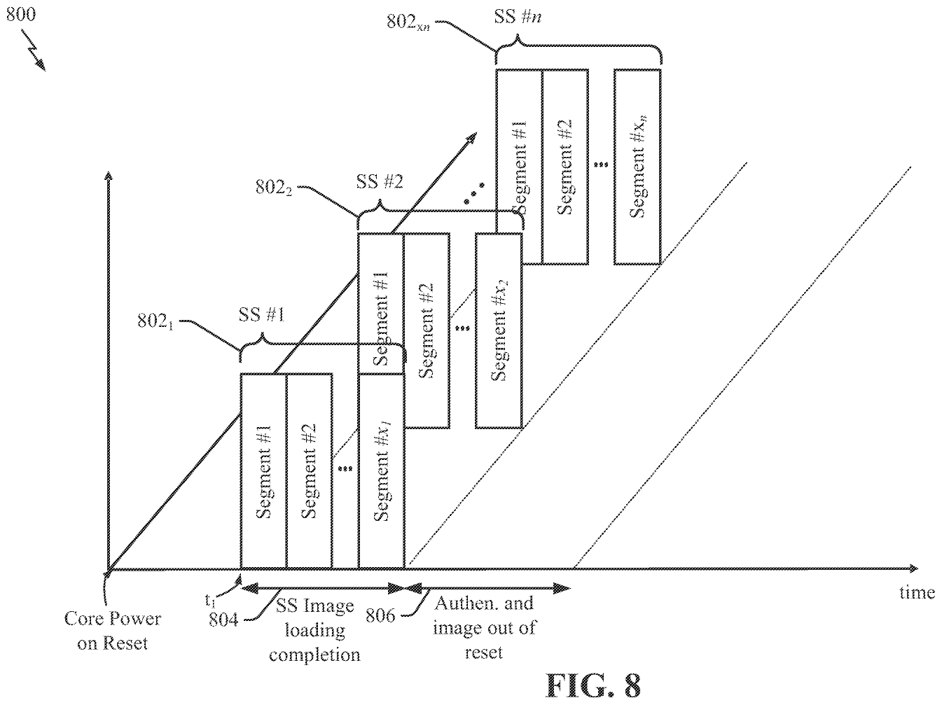

FIG. 7 is a sequence diagram 700 illustrating another exemplary system boot up according to some aspects of the disclosure. In particular, it is noted that FIG. 7 illustrates a method for boot up using parallelism and interleaving of loading and authentication of multiple segments in various images using the DMA and crypto engines. In particular, loading image segments for multiple subsystems is performed in parallel where the subsystem image loading of two or more subsystems occurs concurrently in time, while the image segments for each respective subsystem are loaded linearly or sequentially in time as will be shown in FIG. 8 to be discussed below.

Turning to FIG. 7, this sequence diagram illustrates various hardware and/or software elements involved include a core processor 702 (e.g., AP 104), a Flash/NAND controller 704 (e.g., NVM controller 108), an n number of crypto engines 706₁ through 706ₙ (e.g., engines 114), an n number of DMA engines 708₁ through 708ₙ, and various subsystems 1 through n illustrated by blocks 710₁ through 710ₙ.

During a cold boot or reset boot, the mandatory peripherals such as Flash/NAND controller 704, crypto engines 706 , and DMAs 708 are initialized typically under control of the core processor 702 as shown by initialization signaling 712. It is to be understood that, although not illustrated for sake of clarity, other devices such as a secondary NVM storage device, DRAM, and RAM controller may be included in the initialization processes for the peripheral devices. Once the peripherals are initialized, the core processor 702 triggers respective DMAs 708 to initiate the reading of subsystem images from the secondary NVM storage device (e.g., NVM storage device 110) as shown at 714. In particular, each DMA 708 is tasked with reading a particular subsystem image and will read all segments of a subsystem image out of the NVM storage device linearly in time, while each of the DMAs will operate in parallel (i.e., concurrently in time) reading a respective subsystem image.

According to one example, while the core processor 702 may wait for the DMAs 708 to read the subsystem image segments, the core processor 702 may be placed in a sleep mode as indicated at arrow 716. Once the DMAs 708 complete the reading of their respective subsystem image including all image segments of that image, they may each issue an interrupt signal to wake up the core processor 702 as shown at 718, whereby the DMAs indicate to the core processor 702 that the reading or loading of the image is completed. After the images are loaded, the core processor 702 will trigger or initiate respective crypto engines 706 to calculate the hash values for each of the corresponding subsystem images, each image assigned to a respective crypto engine 706 as shown at 720. Similar to the operation of the DMAs 708, the crypto engines 706₁ through 706ₙ may operate in parallel where the hash values are calculated in parallel by respective ones of the crypto engines 706 for all of the n number of subsystem images.

Once all subsystem hashes are calculated by the crypto engines 706 and returned to the core processor 702 as shown at 722, the complete subsystem image may then be authenticated. Further, the core processor 502 may check the integrity of the subsystem value hash values, which is illustrated by arrow 724. When the authentication and integrity checks are successful, the corresponding n number of subsystems are then brought out of reset (booted up) by the core processor 702 as illustrated by signals 728, 730, and 732. As will be evident to those skilled in the art, the processes shown in the sequence 700 operate such that the multiple DMAs 708 and crypto engines 706 work in parallel to concurrently load the subsystem images, which is faster than a traditional boot flow.

FIG. 8 illustrates a timing diagram 800 of the parallel loading of subsystem images according to some aspects of the disclosure. In particular, FIG. 8 provides an illustration of the timing of the parallel loading and boot up of the n subsystems in accordance with the example of FIG. 7. As shown, after the core power on reset (and also after some time of initialization of the mandatory peripheral devices (not called out but visible at the time prior loading of the subsystem images and also previously shown by signaling 712 in FIG. 7), the loading of each of the n number of subsystem images 802₁ through 802ₓₙ is started at a same time (e.g., t₁ as indicated on the time axis) to thereby load the subsystem images in parallel. After all segments (i.e., segments 1 through x₁ for SS #1, segments 1 through x₂ for SS #2 to segments 1 through xₙ for SS #n) of a subsystem image are loaded over a time as indicated by arrow 804, for example, the subsystems are then authenticated and checked (e.g., processes 720 and 722 in FIG. 7) and brought out of reset as indicated by time period 806. As illustrated, this process is performed in parallel for all subsystems SS #1 through SS #n to be loaded and brought out of reset. It will be appreciated that the use of a dedicated DMA and crypto engine as implemented in the processes of FIG. 7 will bring a particular subsystem out of reset and booted up independent of the other subsystems.

While FIG. 8 illustrates that all subsystem segments are uniform and the time for loading and boot up are the same, those skilled in the art will appreciate that the time for loading the segments may vary from subsystem to subsystem and the time for loading each subsystem image will be dependent on the segment sizes in the respective subsystem image and, therefore, ultimately the subsystem image size. Additionally, the size of the subsystem image affects how quickly the crypto engines may authenticate and check the integrity of the subsystem image. Accordingly, the smaller the image size, the faster the image may be loaded, authenticated, and checked, leading to an earlier out of reset timing (i.e., faster boot up time). The maximum time for bring a system out of reset is therefore directly proportional to the maximum size of a subsystem image.

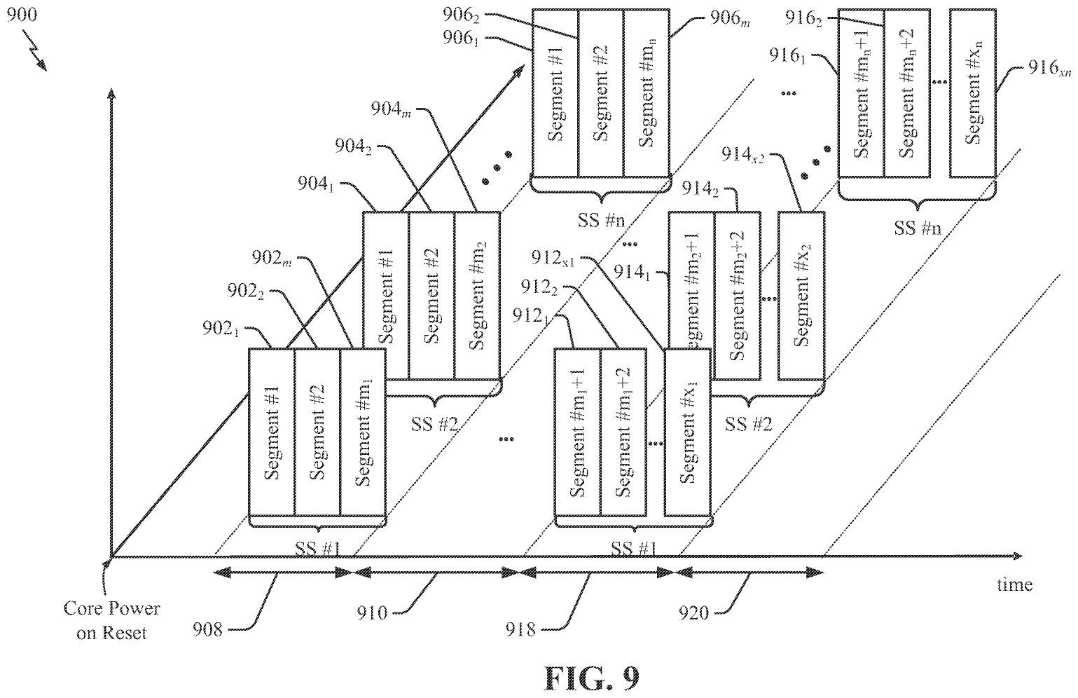

FIG. 9 illustrates a timing diagram 900 of an example of combined parallel loading of segments of subsystem images and the parallel loading of the subsystem images according to some aspects of the disclosure. In this example, the parallelism for image loading is performed for both subsystem segment loading as well as subsystem loading to further decrease image loading times. Furthermore, as will be shown in the example of FIG. 9, a portion of the total number of segments for each subsystem may be loaded and authenticated during a first time period and then another portion of the total number of segments for each subsystem loaded and authenticated during second or more time periods.

As may be seen in FIG. 9, a portion of the total number of segments (e.g., an “m” number of segments) for each of an n number of subsystems (SS #1 through SS #n) may be loaded in parallel after a core power on reset. As may be seen, an “m” number of segments 902₁ through 902ₘ for a first subsystem (SS #1), 904₁ through 904ₘ for a second subsystem (SS #2), to segments 906₁ through 906ₘ for an W subsystem (SS #n), are loaded in parallel over a shared time period indicated with arrow 908. The loading of each of subsystems SS #1 through SS #n may utilize one or more dedicated DMAs to accomplish parallel reading of the subsystems from an NVM storage device, for example. Additionally, the system may utilize dedicated crypto engines for parallel processing of authentication and integrity checks for the m segments over a subsequent time period indicated with arrow 910.

Additionally, FIG. 9 illustrates that after the first authentication/check period 910, another portion of segments, which may or may not be a remainder of the segments for each of the n number of subsystem images, may be loaded in parallel. As shown, segments an “m+1” through “x” number of segments for each subsystem are loaded sequentially (e.g., 912ₘ₊₁ through 912ₓ₁ for a first subsystem (SS #1), 914₁ through 914ₓ₂ for a second subsystem (SS #2), to segments 916₁ through 916ₓₙ for an n^{th} subsystem (SS #n), are loaded in parallel over a shared time period indicated with arrow 918. Additionally, the system may utilize dedicated crypto engines for parallel processing of authentication and integrity checks for the “m+1” through “x” segments over a subsequent time period indicated with arrow 920. If all segments are not loaded, the process will be repeated. Otherwise, after time period 920, the subsystem will be brought out of reset. As will be appreciated by those skilled in the art, each subsystem of subsystems SS #1 through SS #n may utilize one or more dedicated DMAs to accomplish reading from an NVM storage device in order to effect parallel loading of the subsystems.

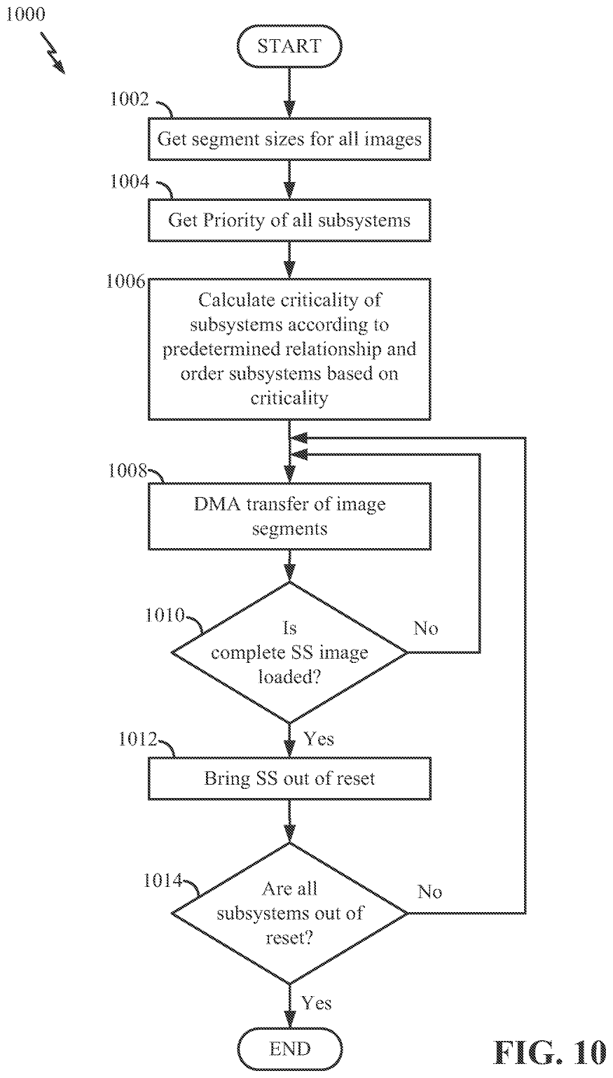

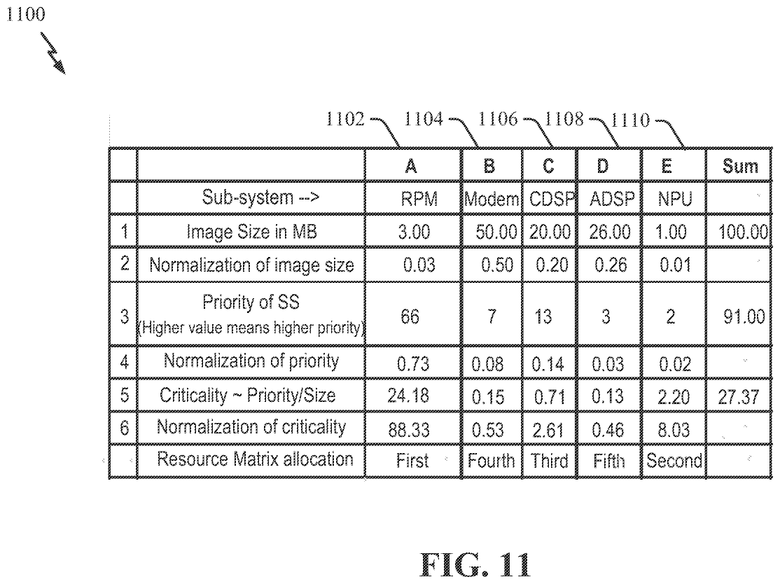

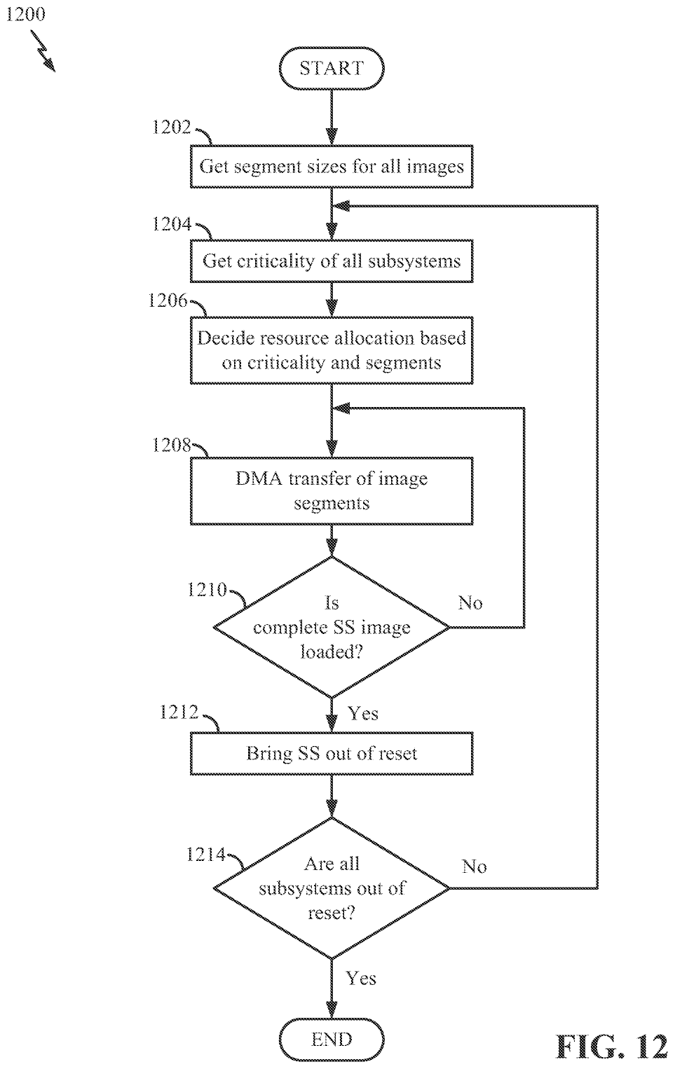

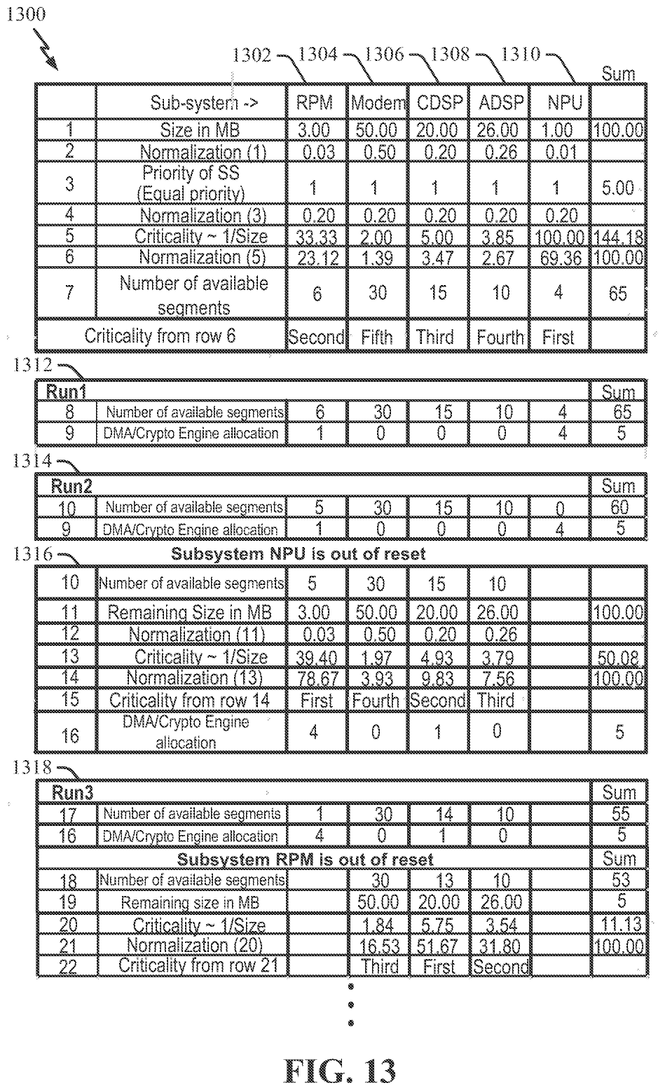

As discussed earlier with regard to FIG. 4, the type of loading characteristic utilized (e.g., FIG. 5 or FIG. 7) will affect the way in which the subsystem loading will be scheduled based on the criticality factor, and even affects how the criticality factor may be determined. Accordingly, the examples that will be shown in FIGS. 10 and 11 illustrate a method for scheduling when parallel reading or loading of segments as shown in FIGS. 5 and 6 is selected, whereas the examples that will be shown in FIGS. 12 and 13 illustrate an alternate method for scheduling when parallel reading or loading of segments as shown in FIGS. 7 and 8 is utilized.

Turning to FIG. 10, this figure illustrates a flow chart showing an exemplary scheduling method 1000 for scheduling a subsystem image read or a subsystem loading order according to some aspects of the disclosure. As shown, scheduling method 1000 includes obtaining segment sizes for all images to be loaded as indicated at block 1002. Additionally, a priority for each of all subsystems to be loaded is obtained as shown in block 1004.

Flow next proceeds to block 1006 where, based on the segment sizes and the subsystem priorities, the criticality of the subsystems are calculated according to a predetermined relationship. In an aspect, the criticality C may be calculated as function of the segment size (S) and the priority (P) according to the relationship C=Func (S,P) where C is proportional to the priority and inversely proportional to the size (C α P and C α 1/S). In this manner, priority P directly affects the value of criticality where the higher priority subsystems will increase criticality, whereas if a subsystem image size is smaller, this will work toward increasing the criticality of the subsystem. Additionally, it may be assumed that a resource allocation (R) is constant. Additionally, the processes of block 1006 may include ordering the subsystem loading based on the determined criticality

After the criticality determination and ordering based on criticality are set, flow proceeds to block 1008 where one or more DMAs will transfer subsystem image segments from memory (e.g., from NVM storage or, alternatively, transfer to DRAM). If a complete image of a subsystem is not yet transferred as determined at decision block 1010, flow returns back to block 1008 until the complete image is loaded. It is also noted that the process of block 1010 may include the authentication and integrity check operations by the crypto engines.

After the complete image of the subsystem is determined to be transferred as determined in decision block 1010, flow proceeds to block 1012 where the subsystem is brought out of reset. Flow then proceeds to decision block 1014 where a determination is made whether all subsystems have been brought out of reset. If not, flow returns to block 1008 for loading further subsystem image segments.

It is noted that scheduling method 1000 may be thought of as a type of monotonic scheduling as the resource matrix (i.e., the determined ordering). In particular, the process of scheduling method 1000 is a one-time process that is not dynamically updated, with a deterministic resource allocation (R), static priorities set for the subsystems, and static criticality values assigned according to the priority monotonic conventions. Accordingly, dynamic changes or updates that may occur in the subsystem availability will not have an impact on the resource allocation.

FIG. 11 is a table 1100 illustrating one example of subsystem ordering and scheduling resulting from the process of FIG. 10. As may be seen in the example of table 1100, five exemplary subsystems are to be brought out of reset; namely a resource power manager (RPM) 1102, a modem 1104, a computational digital signal processor (CDSP) 1106, an audio digital signal processor (ADSP) 1108, and a neural processing unit (NPU) 1110. Of further note, the example illustrated by table 1100 assumes that the number of hardware engines available is fixed at 10 DMAs and 5 crypto engines, but other implementations with different fixed numbers (or variable numbers) of hardware engines are contemplated by the processes disclosed herein.

Corresponding to process 1002 in FIG. 10, image sizes in MB for each of the subsystems are derived and tabulated as shown in entry row 1. A sum of these sizes may also be calculated for purposes of determining normalized values of the sizes shown in row 2.

Consistent with process 1004 in FIG. 10, priority values for each of the subsystems are also obtained and tabulated as shown in row 3 of table 1100, where one convention that may be employed is that a higher value denotes a higher priority level. The sum of the priority values may be calculated in order to normalize the priority values as shown in row 4 of table 1100.

Once priority and size are known, the criticality value may then be determined where the value is directly proportional to a priority value and indirectly (i.e., inversely) proportional to the subsystem image size. These calculated values are shown in row 5 of table 1100 where the higher the number indicates the higher the criticality. A summation of these criticality values may also be calculated for purposes of normalizing the criticality values as shown in row 6 of table 1100.

Based on the determined criticality values, the resource matrix allocation (e.g., the ordering of loading the subsystems) may be determined. As may be seen in this example, the RPM 1102 is scheduled first, followed by NPU 1110, CDSP 1106, modem 1104, and ADSP 1108 fifth corresponding to their highest to lowest criticality values. Of particular note, even though the NPU 1110, for example, has the lowest priority, because of its small size, this subsystem is nonetheless the second most critical subsystem to bring out of reset in terms of minimizing the boot up time of the system as a whole. The traditional boot up processes based on mere priority, however, would bring subsystem 1110 out of reset last, but would increase the overall boot up time and not achieve the efficiency engender by using the criticality measure.

FIG. 12 is a flow chart illustrating another exemplary method 1200 for scheduling subsystem image read order according to some other aspects of the disclosure. In particular, the method 1200 may be utilized when employing parallel loading of subsystems as illustrated in FIGS. 7 and 8. The scheduling effected by method 1200 is a dynamic scheduling effecting adaptive ordering of subsystem image loading that varies as subsystems are loaded and brought out of reset.

Method 1200 first includes determining the segment sizes for all images to be loaded as illustrated in block 1202. The process of block 1202 may be implemented with the NVM controller (e.g., NVM controller 108) reading metadata from the image data stored in the NVM storage device (e.g., 110). After obtaining the size information, flow proceeds to block 1204 where the criticality for all of the subsystems is obtained. In an aspect, the criticality may be based on the image size where the criticality C is a function of size (S) according to a relationship C=Func (S) where C is inversely proportional to the subsystem image size S (i.e., C α 1/S).

After the criticality determination at block 1204, flow proceeds to block 1206 where resource allocation is determined. It is noted here that the resource allocation R in method 1200 is dynamic and a function of the criticality (i.e. R=Func(C)) as the criticality C of the system is dynamically calculated based on the currently availability of the subsystem(s). In further aspects, the resource allocation may be based on the number of subsystem segments for a subsystem image, as will be further explained with reference to the example of FIG. 13.

After the criticality determination and resource allocation determination, flow proceeds to block 1208 where one or more DMAs will transfer subsystem image segments from memory (e.g., from NVM storage or, alternatively, transfer to DRAM). If a complete image of a subsystem is not yet transferred as determined at decision block 1210, flow returns back to block 1208 until the complete image is loaded. It is also noted that the process of block 1210 may include the authentication and integrity check operations by the crypto engines.

After the complete image of the subsystem is determined to be at decision block 1210, flow proceeds to block 1212 where the subsystem is brought out of reset. Flow then proceeds to decision block 1214 where a determination is made whether all subsystems have been brought out of reset. If not, flow returns to block 1204 for recalculation of the criticality values as the method 1200 features dynamic allocation based on the currently available subsystems, which changed due to the process of block 1212. The processes of blocks 1204-1214 repeat with the dynamic calculation of the criticality (i.e., a recalculation of the criticality values) made after a subsystem has been brought out of reset up to the point when all subsystems have been brought out of reset as determined in block 1214. This repeating of the processes of blocks 1204-1214 also includes adjusting the dynamic ordering of the loading of the remaining plurality of subsystem images based on the recalculated criticality values, the number of image segments in each subsystem image, and the fixed number of hardware resources available for performing loading of the subsystem images.

FIG. 13 is a further table 1300 illustrating an example of scheduling resulting from the processes of FIG. 12. Similar to the example in FIG. 11, five exemplary subsystems are to be brought out of reset; namely a resource power management an RPM 1302, a modem 1304, a CDSP 1306, an ADSP 1308, and an NPU 1310. Of further note, the example illustrated by table 1300 assumes, for only the purposes of example, that the number of hardware resources available for performing loading of images and authenticating/checking is 5 DMAs and 5 crypto engines, but other implementations with different numbers of hardware engines are contemplated by the processes disclosed herein.

Corresponding to process 1202 in FIG. 12, image sizes in MB for each of the subsystems are derived and tabulated as shown in entry row 1. A sum of these sizes may also be calculated for purposes of determining normalized values of the sizes as shown in row 2. The priority values (P) for each of the subsystems are equalized in this example, wherein each subsystem is given the same priority value of one (1) as may be seen in row 3. The sum of the priority values may be calculated in order to normalize the priority values as shown in row 4 of table 1300.

Consistent with the process shown in block 1204, the criticality values C are determined inversely to the size of the images and tabulated as shown in row 5 of table 1300. Thus, the smallest image size for RPM 1302 (e.g., a 3 MB size for sake of showing a representative size, but not limited to such), has the largest C value, whereas the largest image size modem 1304 (e.g., 50 MB, but not limited to such) has the smallest C value. Further, the C values may be normalized based on the sum of the C values as shown in row 6. Additionally, the number of segments for the subsystem image is obtained as shown in row 7. As would be expected, the smaller subsystem images will have a corresponding lesser number of segments.

Based on the determined criticality C values, the resource matrix allocation (e.g., the ordering of loading the subsystems) may be determined. As may be seen in this example at a first run 1312 of loading subsystem images, the resource allocation that corresponds to the process in block 1206 accounts for the number of available segments as well as the criticality. In the example of run 1 at 1312, DMA engine allocation is configured to favor the subsystem with the greatest criticality, which is NPU 1310 in this example. In order to not allocate all resources to one subsystem, four DMA engines may be allocated to loading the subsystem segments for NPU 1310 as may be seen in row 8, and one DMA engine is allocated to RPM 1302. This allocation may be based on any one of a number of various methods of rounding which can be used to divide resources and contain the sum to the maximum number of available hardware resources. Examples of these methods may include, but are not limited to, a Hamilton method of approximation, or summing the decimals of lower numbers to the higher number. In particular, the summing may be accomplished by flooring all normalized resource numbers; determining the difference between the sum and the maximum number of resources, and then distributing the difference by adding to the subsystem with the highest criticality.

After the image segments are loaded in run 1 1312, it will be appreciated that three of the available four segments for NPU 1310 have been loaded and one of six available segments for RPM 1302 have been loaded, thus leaving one segment for NPU 1310 to yet be loaded and five segments for RPM 1302, which may be seen at row 7 in the table for Run 2 at 1314.

It is noted that the process of Run 1 1312 may correspond to process 1208 in FIG. 12 and subsequent run 2 1314 would be the process of block 1208 after looping back from decision block 1210 For run 2 (i.e., implementation of the process shown in block 1208 of FIG. 12), the resource allocation remains static since the determination at block 1210 yielded a negative as may be seen in row 8 of run 2 1314; i.e., DMA engine allocation remains at one engine for RPM 1302 and four DMA engines for NPU 1310. The execution of the processes of block 1208 in run 2 will then result in all segments of the subsystem image for NPU 1310 being loaded and four segments remaining for the RPM 1302 as shown at line 9 (i.e., second occurrence of line 9).

After Run 2 at 1314, the NPU subsystem 1310 will be brought out of reset, which corresponds to the condition of decision block 1210 resulting in a positive “Yes” leading to the subsystem 1310 being brought out of reset. Further, since the other four subsystems (i.e., 1302, 1304, 1306, and 1308) are not yet out of reset, the flow of method 1200 would return to block 1204 for a recalculation of the criticality of the remaining subsystems and reallocation of resources, which is exemplified in table 1300 at lines 10-16 in table portion 1316.

As may be seen at portion 1316, the criticality values are recalculated as may be seen in row 13 of portion 1316. In this recalculation, the criticality of subsystem RPM 1302 is now greatest as may be seen in row 15, which would yield a prioritization of DMA resources being allocated to this subsystem. Here, the RPM 1302 now has the highest criticality and CDSP 1306 is second in criticality. Again, according to a predetermined method, such as a rounding method, RPM 1302 is allocated four DMAs and CDSP 1306 is allocated one DMA of the five available DMAs in this example.

Next a third run (Run 3) shown at 1318 is performed, where one segment remains to be processed for RPM 1302 since the 5 segments available for RPM 1302 were allocated 4 DMAs in Run 2. Thus, after Run 3, the RPM 1302 will be brought out of reset (i.e., corresponding to block 1212 determination in FIG. 12), but since more subsystems remain, further reallocation will be performed (i.e., corresponding to loop from 1214 to 1204 in FIG. 12). As may be seen in lines 18-22 of the Run 3 portion 1318 of table 1300, the criticality is predetermined such that CDSP 1306 is first and ADSP 1308 is now second. The process continues in this manner until all subsystems are brought out of reset.

FIG. 14 is a block diagram conceptually illustrating an example of a hardware implementation for a computing system 1400 such as a wireless communications device according to some aspects of the disclosure. The computing device 1400 may include a processing system 1402, which may be configured as system on chip (SoC) in one example. The processing system 1402 may include a processor 1404 such as a core processor or application processor. Further examples of processors that may be used to implement the processing system 1402 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

The processor 1404 may be communicatively coupled to a system bus 1406 within processing system 1402 enabling communication between components within the processing system 1402, as well as with other devices within the computing device 1400 via a bus interface 1408. The bus interface 1408 is coupled various peripheral device 1410 with device 1400 such as a camera, touch screen, keypad, speaker, microphone, gyroscope sensors, accelerometers, or a GPS modem, as just a few examples. Additionally, it is noted that while this example illustrates the processing system 1402 implemented with a bus architecture, the bus 1406 may include any number of interconnecting buses and bridges depending on the specific application of the processing system 1402 and the overall design constraints. Furthermore, the bus interface 1408 may also be configured to include NVM storage and DRAM busses that are configured to communicatively couple with memory controller devices 1412 in hardware circuitry 1414, in one example, but not limited to hardware. Further, the memory controller devices 1412 are communicatively coupled to a secondary memory or storage 1416, which may comprise a non-volatile memory storage device such as Flash or NAND storage, and a main memory device 1418, such as a DRAM, SDRAM, DDR DRAM, etc.

Additionally processing system 1402 may include further memory 1420 coupled to the bus 1406. In an example of computing device 1400 comprising a wireless communications device, the bus interface 1408 may further be communicatively coupled with transceiver and Radio Frequency (RF) chain for wireless communication with a communication network.

In further aspects, the processor 1404 may be responsible for managing the bus 1406 and general processing, including the execution of software stored on a computer-readable medium 1426. The software, when executed by the processor 1406, causes the processing system 614 to perform the various functions described below for any particular apparatus. The computer-readable medium 1426, memory 1420, and/or main memory 1418 may also be used for storing data that is manipulated by the processor 1404 when executing software.

One or more processors or at least one processor 1404 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable storage medium 1426. The computer-readable storage medium 1426 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1426 may reside in the processing system 1402, external to the processing system 1402, or distributed across multiple entities including the processing system 1402. The computer-readable medium 1426 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, the hardware circuitry 1414 may also include direct memory access circuitry 1432, such as the DMA engine discussed earlier. Furthermore, the hardware circuitry 1414 may include cryptography engine circuitry 1434 such as the various crypto engines discussed earlier. In some aspects, the direct memory access circuitry 1432 and cryptography engine circuitry 1434 may be controlled by the processor 1404. For example, for operations such as subsystem image loading from secondary memory 1416 to main memory 1418, the processor 1404 may direct the direct memory access circuitry 1432 and cryptography engine circuitry 1434, in conjunction with memory controller 1412, to perform the various functions such as direct memory access to load subsystem images, as well as perform authentication and integrity checks on the loaded or read images. In particular, the processor 1414 may trigger or control operation of the hardware circuitry 1414 to function according to the previously disclosed examples in FIGS. 1-13.

In one or more further examples, the computer-readable storage medium 1426 may store or include computer-executable code, software, or instructions 1452 configured for various functions, including, for example, determining the criticality values discussed herein. In an aspect, the instructions 1452 are executed by at least one processor 1404 to calculate and determine criticality values as were discussed relation to FIGS. 4 and 10-13. In some other aspects of the disclosure, the computer-readable storage medium 14 may include code, software or instructions 1454 configured for various functions, including, for example, selecting a subsystem image loading characteristic, such as the various parallel loading characteristics detailed before with respect to FIGS. 5-9. Yet further, the computer-readable storage medium 1426 may include code, software, or instructions 1456 configured for various functions, including, for example, determining the resource allocation for scheduling as was discussed specifically in connection with FIGS. 10-13, as well as resource allocation as was discussed in connection with the examples of FIGS. 12 and 13 wherein hardware devices such as the direct memory access circuit 1432 is selectively allocated to subsystems when loading multiple subsystem images in parallel.

Of further note, according to certain types of computing systems the computing system 1400 could be configured to include certain subsystems outside of the SoC 1402. Such an option is illustrated by other subsystems 1460 in FIG. 14, which are attachments to the SoC 1402. Examples of such other subsystems 1460 may include modem attachments or NPU attachments whose images are loaded by a system master processor (e.g., APSS).

Of further note concerning the methods 400, 1000, and 1200 shown in FIGS. 4, 10, and 12, respectively, these methods may further include determining a criticality value C based on the determined parameters including at least on one or more of sizes of segments of the subsystem images and a priority value of a subsystem, such as was discussed in connection with FIGS. 10-13. In further aspects, the criticality value C is specifically determined based on an inverse relationship between the criticality value and the one or more sizes of segments of the subsystem images, such as was discussed above in connection with FIGS. 10 and 11 (e.g., C α Priority/Size), as well as FIGS. 12 and 13 (e.g., C α 1/Size). Furthermore, the criticality value C may be specifically determined based on a direct relationship between the criticality value and the priority value of the subsystem as was discussed in connection with FIGS. 10 and 11 (e.g., C α Priority/Size).

Additionally, it is noted that the loading characteristic may include loading subsystem images from a storage device (.e.g., NVM storage device 108) into the computing system (e.g., system 100) in parallel where one or more segments for each subsystem image of the plurality of subsystem images are read from the storage device concurrently in time. Furthermore, the methods disclosed herein may include scheduling the order of loading of the subsystem images from the storage device into the computing system by determining the criticality value based on both a priority value of each subsystem image and a size of each subsystem image, and ordering the loading of subsystem images based on the criticality values where the order of subsystem loading is from highest to lowest criticality. In further aspects, the disclosed methods may include the criticality value calculated based on a proportional relationship of the criticality value to the priority value and an inverse relationship of the criticality value to the size of the subsystem.

In still further aspects, the methods disclosed herein may include that the priority value and the size value are determined by reading data associated with subsystem images stored in the storage device. In still other aspects, loading of the subsystem images may be performed using a fixed resource allocation including a fixed number of direct memory access engines and cryptography engines allocated for loading and authenticating the parallel loaded segments of each subsystem image.

In still other aspects, the methods herein may include that the loading characteristic comprises loading subsystem images from by storage device into the computing system in parallel where one or more subsystem images of the plurality of subsystem images are read from the storage device concurrently in time. Moreover, one or more segments of each of the plurality of subsystem images are read sequentially in time. Additionally, the disclosed methods may include scheduling the order of loading of the subsystem images from the storage device into the computing system through calculating the criticality value for each subsystem image based on a size of each respective subsystem image, and dynamically ordering the loading of one or more subsystem images based on the determined criticality values, a number of image segments in each subsystem image, and the number of hardware resources available for performing loading of the subsystem images. According to yet other aspects, the methods may include recalculating the criticality value for each remaining subsystem image of the plurality of subsystem images after a subsystem has be brought out a reset condition; and adjusting the dynamic ordering of the loading of the remaining plurality of subsystem images based on the recalculated criticality values, the number of image segments in each subsystem image, and the number of hardware resources available for performing loading of the subsystem images. Further, the criticality value is calculated based on an inverse relationship of the criticality value to the size of each respective subsystem image.

Additionally, it is noted that processes within the methodologies discussed herein may be further effectuated with means for determining the criticality value based on determined parameters including at least on one or more of sizes of segments of the subsystem images and a priority value of a subsystem. This means may be implemented by AP 104, a subsystem such as subsystem 106, core processor 502, core processor 702, processor 1404, hardware 1414, combinations thereof, or other equivalent means. Still further, other disclosed processes may be implemented with means for selecting the loading characteristic further comprises means for loading subsystem images from the storage device into the computing system in parallel where one or more segments for each subsystem image of the plurality of subsystem images are read from the storage device concurrently in time. This means may be implemented by AP 104, a subsystem such as subsystem 106, core processor 502, core processor 702, processor 1404, hardware 1414, NVM controller 108, DMAs 112, 508, or 708, combinations thereof, or other equivalent means. Also, certain processes in methods disclosed herein may be implemented with a means for selecting the loading characteristic further comprises means for loading subsystem images from by storage device into the computing system in parallel where one or more subsystem images of the plurality of subsystem images are read from the storage device concurrently in time. This means may be implemented by AP 104, a subsystem such as subsystem 106, core processor 502, core processor 702, processor 1404, hardware 1414, NVM controller 108, DMAs 112, 508, or 708, combinations thereof, or other equivalent means.

Several aspects of computing systems have been presented with reference to various exemplary implementations. As those skilled in the art will readily appreciate, various aspects described throughout this disclosure may be extended to other computing systems and computer architectures.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another, even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A method for booting a computing system, the method comprising:
determining a criticality value for each of a plurality of subsystems based on determined parameters;
selecting a loading characteristic by which subsystem images corresponding to the one or more of the plurality of subsystems are read from a storage device into the computing system; and
scheduling an order of loading the subsystem images from the storage device into the computing system based on the determined criticality value and the selected loading characteristic for booting up the plurality of subsystems in the computing system.

2. The method of claim 1, further comprising:
determining the criticality value based on the determined parameters including at least on one or more of sizes of segments of the subsystem images and a priority value of a subsystem.

3. The method of claim 2, wherein the criticality value is determined based on an inverse relationship between the criticality value and the one or more sizes of segments of the subsystem images.

4. The method of claim 2, wherein the criticality value is determined based on a direct relationship between the criticality value and the priority value of the subsystem.

5. The method of claim 1, wherein the loading characteristic comprises loading subsystem images from the storage device into the computing system in parallel where one or more segments for each subsystem image of the plurality of subsystem images are read from the storage device concurrently in time.

6. The method of claim 5, wherein scheduling the order of loading of the subsystem images from the storage device into the computing system further comprises:
determining the criticality value based on both a priority value of each subsystem image and a size of each subsystem image; and
ordering the loading of subsystem images based on the criticality values where the order of subsystem loading is from highest to lowest criticality.

7. The method of claim 6, wherein the criticality value is calculated based on a proportional relationship of the criticality value to the priority value and an inverse relationship of the criticality value to the size of the subsystem.

8. The method of claim 6, wherein the priority and size values are determined by reading data associated with subsystem images stored in the storage device.

9. The method of claim 5, wherein loading of the subsystem images is performed using a fixed resource allocation including a fixed number of direct memory access engines and cryptography engines allocated for loading and authenticating the parallel loaded segments of each subsystem image.

10. The method of claim 1, wherein the loading characteristic comprises loading subsystem images from by storage device into the computing system in parallel where one or more subsystem images of the plurality of subsystem images are read from the storage device concurrently in time.

11. The method of claim 10, wherein one or more segments of each of the plurality of subsystem images are read sequentially in time.

12. The method of claim 10, wherein scheduling the order of loading of the subsystem images from the storage device into the computing system further comprises:
calculating the criticality value for each subsystem image based on a size of each respective subsystem image; and
dynamically ordering the loading of one or more subsystem images based on the determined criticality values, a number of image segments in each subsystem image, and the number of hardware resources available for performing loading of the subsystem images.

13. The method of claim 12, further comprising:
recalculating the criticality value for each remaining subsystem image of the plurality of subsystem images after a subsystem has be brought out a reset condition; and
adjusting the dynamic ordering of the loading of the remaining plurality of subsystem images based on the recalculated criticality values, the number of image segments in each subsystem image, and the number of hardware resources available for performing loading of the subsystem images.

14. The method of claim 10, wherein the criticality value is calculated based on an inverse relationship of the criticality value to the size of each respective subsystem image.

15. The method of claim 1, wherein the plurality of subsystems comprises one more or a graphics processing unit, an IP accelerator, a wide area network modem unit, a wireless local area network (WLAN) modem unit, a digital signal processor (DSP), computational DSP (CDSP), an audio DSP (ADSP), a video processor, a camera unit, a power monitor, or a neural processing unit (NPU), and one or more of the plurality of subsystems may be within a system on a chip (SoC) or external to the SoC.

16. An apparatus for booting a computing system comprising:
means for determining a criticality value for each of a plurality of subsystems based on determined parameters;
means for selecting a loading characteristic by which subsystem images corresponding to the one or more of the plurality of subsystems are read from a storage device into the computing system; and
means for scheduling an order of loading the subsystem images from the storage device into the computing system based on the determined criticality value and the selected loading characteristic for booting up the plurality of subsystems in the computing system.

17. The apparatus of claim 16, further comprising:
means for determining the criticality value based on the determined parameters including at least on one or more of sizes of segments of the subsystem images and a priority value of a subsystem.

18. The apparatus of claim 17, wherein the criticality value is determined based on an inverse relationship between the criticality value and the one or more sizes of segments of the subsystem images.

19. The apparatus of claim 17, wherein the criticality value is determined based on a direct relationship between the criticality value and the priority value of the subsystem.

20. The apparatus of claim 16, wherein the means for selecting the loading characteristic further comprises means for loading subsystem images from the storage device into the computing system in parallel where one or more segments for each subsystem image of the plurality of subsystem images are read from the storage device concurrently in time.

21. The apparatus of claim 16, wherein the means for selecting the loading characteristic further comprises means for loading subsystem images from by storage device into the computing system in parallel where one or more subsystem images of the plurality of subsystem images are read from the storage device concurrently in time.

22. A computer-readable medium storing computer-executable code, comprising code for causing a computer to:
determine a criticality value for each of a plurality of subsystems, which are executable on a computing system, based on determined parameters;
select a loading characteristic by which subsystem images corresponding to the one or more of the plurality of subsystems are read from a storage device into the computing system; and
schedule an order of loading the subsystem images from the storage device into the computing system based on the determined criticality value and the selected loading characteristic for booting up the plurality of subsystems in the computing system.

23. The computer-readable medium of claim 22, further comprising code for causing a computer to:
determine the criticality value based on the determined parameters including at least on one or more of sizes of segments of the subsystem images and a priority value of a subsystem.

24. The computer-readable medium of claim 23, further comprising code for causing a computer to determine the criticality value based on an inverse relationship between the criticality value and the one or more sizes of segments of the subsystem images.

25. The computer-readable medium of claim 23, wherein the criticality value is determined based on a direct relationship between the criticality value and the priority value of the subsystem.

26. The computer-readable medium of claim 22, further comprising code for causing a computer to:
select the loading characteristic for loading subsystem images from the storage device into the computing system in parallel where one or more segments for each subsystem image of the plurality of subsystem images are read from the storage device concurrently in time.

27. The computer-readable medium of claim 22, further comprising code for causing a computer to:
select the loading characteristic further comprises means for loading subsystem images from by storage device into the computing system in parallel where one or more subsystem images of the plurality of subsystem images are read from the storage device concurrently in time.

28. An apparatus comprising:
at least one processor;
at least one memory storage communicatively coupled to the at least one processor,
wherein the at least one processor is configured to:
determine a criticality value for each of a plurality of subsystems based on determined parameters;
select a loading characteristic by which subsystem images corresponding to the one or more of the plurality of subsystems are read from a storage device into the computing system; and
schedule an order of loading the subsystem images from the storage device into the computing system based on the determined criticality value and the selected loading characteristic for booting up the plurality of subsystems in the computing system.

29. The apparatus of claim 28, wherein the at least one processor is further configured to determine the criticality value based on the determined parameters including at least on one or more of sizes of segments of the subsystem images and a priority value of a subsystem.

30. The apparatus of claim 29, wherein the at least one processor is further configured to determine the criticality value based on at least one of an inverse relationship between the criticality value and the one or more sizes of segments of the subsystem images or on a direct relationship between the criticality value and the priority value of the subsystem.
